(19) United States
(12) Patent Application Publication
(10) Pub. No.: US 2026/0022482 A1
(43) Pub. Date: Jan. 22, 2026

(54) A SYSTEM AND A METHOD FOR ESTIMATING CURRENT EFFICIENCY OF AN ELECTROLYSER

(71) Applicant: NEOVOLT OY, VANTAA (FI)

(72) Inventors: Joonas KOPONEN, VANTAA (FI); Anton KRIMER, VANTAA (FI); Olli LIUKKONEN, VANTAA (FI)

(21) Appl. No.: 18/992,133

(22) PCT Filed: Jul. 1, 2023
(86) PCT No.: PCT/FI2023/050421

§ 371 Date: Jan. 7, 2025

(30) Foreign Application Priority Data
Jul. 8, 2022 (FI) 20225644

(51) Int. Cl. C25B 15/023; C25B 1/04; G06F 1/20

(52) U.S. Cl. CPC C25B 15/023; G06F 1/206; C25B 1/04

(57) ABSTRACT

An estimation system for estimating current efficiency of an electrolyser comprises a data processing system (105) for computing heat loss of the electrolyser based on specific heat capacity of electrolyte, a flow rate of the electrolyte in a cathode side of the electrolyser, a flow rate of the electrolyte in an anode side, a temperature difference (T1c-T0c) between electrolyte circulation outlet and inlet of the cathode side, and a temperature difference (T1a-T0a) between electrolyte circulation outlet and inlet of the anode side. The current efficiency is estimated based on a difference between electric power supplied to the electrolyser and the computed estimate of the heat loss, and on a product of thermoneutral voltage of electrolysis cells of the electrolyser and electric current supplied to the electrolyser.

### FIELD OF THE DISCLOSURE

The disclosure relates to a system, to a method, and to a computer program for estimating current efficiency of an electrolyser, e.g. an alkaline water electrolyser, a proton exchange membrane “PEM” water electrolyser, or an electrolyser of brine. Furthermore, the disclosure relates to an electrolyser system, to a method for controlling an electrolyser system, and to a computer program for controlling an electrolyser system.

### BACKGROUND

In water electrolysis, water is electrochemically decomposed by electrical energy using two electrodes immersed in electrolyte. Hydrogen H₂ is formed at a cathode and oxygen O₂ is formed at an anode. For this electrochemical reaction to succeed, either protons H+ or hydroxide ions OH-must travel through electrolyte which can be either a liquid or a solid. Water itself is poor medium for charge transfer, and thus the electrolyte for water electrolysis is enhanced in terms of conductivity. To improve charge transfer, the electrolyte selected is typically either a strong base or a strong acid.

Alkaline water electrolysis is a widely used and mature water electrolysis technology. An alkaline water electrolysis cell comprises two electrodes operating in a liquid electrolyte solution, e.g. potassium hydroxide KOH or sodium hydroxide NaOH. The electrodes are separated by a diaphragm permeable to hydroxide ions and water. For system safety, the diaphragm should be thick as it prevents mixing of hydrogen H₂ and oxygen O₂ gases produced at cathode and anode electrodes, respectively. Hydroxide ions are penetrating the porous diaphragm and provide ionic conductivity required for the electrolysis process.

A notable degrading factor for the energy efficiency of alkaline water electrolysis systems is the inclination to stray current flows. In traditional alkaline water electrolysers, an anolyte circulation connects all anode electrodes and correspondingly a catholyte circulation connects all cathode electrodes through the liquid electrolyte and thereby offer stray current paths for the electric current to shunt through. Because of these stray current paths, series connected electrolysis cells may be loaded in a non-uniform manner leading to a decrease in system performance and accelerated degradation of the electrolyser. Furthermore, the anolyte and catholyte circulations may be continuously or periodically mixed to minimize the concentration gradient generated in normal alkaline water electrolysis operation. Valve controlled electrolyte mixing may provide an additional pathway for flow of electric charge. Stray currents, also called shunt currents, of the kind described above increase a specific energy consumption of an electrolyser. Thus, there is a need for technologies to estimate current efficiency nc of an electrolyser to make it possible to optimize operation of the electrolyser, wherein the current efficiency nc expresses a ratio of electric current via an electrolyser stack constituted by electrolysis cells to total electric current supplied to the electrolyser and including both the electric current via the electrolyser stack and the stray currents.

### SUMMARY

The following presents a simplified summary to provide a basic understanding of some aspects of various embodiments. The summary is not an extensive overview of the invention. It is neither intended to identify key or critical elements of the invention nor to delineate the scope of the invention. The following summary merely presents some concepts in a simplified form as a prelude to a more detailed description of exemplifying and non-limiting embodiments.

In accordance with the invention, there is provided a new estimation system for estimating current efficiency of an electrolyser. The electrolyser can be, for example but not necessarily, an alkaline water electrolyser, a proton exchange membrane “PEM” water electrolyser, or an electrolyser of brine such as a chlor-alkali electrolyser.

An estimation system according to the invention comprises:
temperature sensors at an inlet of an electrolyte circulation of a cathode side of the electrolyser, at an outlet of the electrolyte circulation of the cathode side of the electrolyser, at an inlet of an electrolyte circulation of an anode side of the electrolyser, and at an outlet of the electrolyte circulation of the anode side of the electrolyser, and
a data processing system configured to compute:
   an estimate for heat loss of the electrolyser based on specific heat capacity of electrolyte, a flow rate of the electrolyte in the electrolyte circulation of the cathode side, a flow rate of the electrolyte in the electrolyte circulation of the anode side, a temperature difference of the electrolyte between the outlet and inlet of the cathode side, and a temperature difference of the electrolyte between the outlet and inlet of the anode side, and
   an estimate for the current efficiency based on a difference between electric power supplied to the electrolyser and the computed estimate of the heat loss of the electrolyser, and on a product of thermoneutral voltage of electrolysis cells of the electrolyser and electric current supplied to the electrolyser.

In the above-described estimation system, the estimate of the heat loss which is, in turn, used for obtaining the estimate of the current efficiency is formed with a calorimetric method. The estimate of the current efficiency makes it possible to control the electric current supplied to the electrolyser so that the current efficiency or another quantity, e.g. specific energy consumption, dependent on the current efficiency can be optimized. The optimization can be e.g. maximization of the current efficiency or minimization of the specific energy consumption. Thus, the meaning of the optimization is dependent on the quantity being optimized. Furthermore, the estimate of the current efficiency makes it possible to estimate the production rate of hydrogen H₂ without a production flow rate measurement.

In accordance with the invention, there is also provided a new electrolyser system that comprises:
one or more electrolysers each comprising an electrolyser stack having electrolysis cells containing electrolyte,
one or more controllable electric power sources each being configured to supply controllable direct voltage to one of the electrolysers so that each of the electrolysers is supplied with one of the controllable electric power sources,
an estimation system according to the invention for estimating the current efficiency related to each of the electrolysers, and
a control system configured to control the direct voltage of each of the controllable electric power sources to optimize the estimated current efficiency or another quantity dependent on the estimated current efficiency of the electrolyser supplied by the controllable electric power source.

In accordance with the invention, there is also provided a new estimation method for estimating current efficiency of an electrolyser. The estimation method according to the invention comprises:
measuring temperature of electrolyte at an inlet of an electrolyte circulation of a cathode side of the electrolyser, temperature of the electrolyte at an outlet of the electrolyte circulation of the cathode side of the electrolyser, temperature of the electrolyte at an inlet of an electrolyte circulation of an anode side of the electrolyser, and temperature of the electrolyte at an outlet of the electrolyte circulation of the anode side of the electrolyser,
forming, by a data processing system, an estimate for heat loss of the electrolyser based on specific heat capacity of the electrolyte, a flow rate of the electrolyte in the electrolyte circulation of the cathode side, a flow rate of the electrolyte in the electrolyte circulation of the anode side, a temperature difference of the electrolyte between the outlet and inlet of the cathode side, and a temperature difference of the electrolyte between the outlet and inlet of the anode side, and
forming, by the data processing system, an estimate for the current efficiency based on a difference between electric power supplied to the electrolyser and the computed estimate of the heat loss of the electrolyser, and on a product of thermoneutral voltage of electrolysis cells of the electrolyser and electric current supplied to the electrolyser.

In accordance with the invention, there is also provided a new control method for controlling an electrolyser system that comprises one or more electrolysers each comprising an electrolyser stack having electrolysis cells containing electrolyte, and one or more controllable electric power sources each being configured to supply controllable direct voltage to one of the electrolysers so that each of the electrolysers is supplied with one of the controllable electric power sources. The control method according to the invention for controlling the electrolyser system comprises:
carrying out an estimation method according to the invention for estimating current efficiency of each of the electrolysers, and
controlling, by a control system, the direct voltage of each of the controllable electric power sources to optimize the estimated current efficiency or another quantity dependent on the estimated current efficiency of the electrolyser supplied by the controllable electric power source.

In accordance with the invention, there is also provided a new computer program for estimating current efficiency of an electrolyser. The computer program according to the invention comprises computer executable instructions for controlling a programmable data processing system to:
receive temperature values indicative of temperature of electrolyte at an inlet of an electrolyte circulation of a cathode side of the electrolyser, temperature of the electrolyte at an outlet of the electrolyte circulation of the cathode side of the electrolyser, temperature of the electrolyte at an inlet of an electrolyte circulation of an anode side of the electrolyser, and temperature of the electrolyte at an outlet of the electrolyte circulation of the anode side of the electrolyser,
form an estimate for heat loss of the electrolyser based on specific heat capacity of the electrolyte, a flow rate of the electrolyte of the electrolyte circulation of the cathode side, a flow rate of the electrolyte of the electrolyte circulation of the anode side, a temperature difference of the electrolyte between the outlet and inlet of the cathode side, and a temperature difference of the electrolyte between the outlet and inlet of the anode side, and
compute an estimate for the current efficiency based on a difference between electric power supplied to the electrolyser and the computed estimate of the heat loss of the electrolyser, and on a product of thermoneutral voltage of electrolysis cells of the electrolyser and electric current supplied to the electrolyser.

In accordance with the invention, there is also provided a new computer program for controlling an electrolyser system that comprises one or more electrolysers each comprising an electrolyser stack having electrolysis cells containing electrolyte, and one or more controllable electric power sources each being configured to supply controllable direct voltage to one of the electrolysers so that each of the electrolysers is supplied with one of the controllable electric power sources.

The computer program according to the invention for controlling the above-mentioned electrolyser system comprises a computer program according to the invention for estimating current efficiency of each electrolyser of the electrolyser system, and computer executable instructions for controlling a programmable data processing system to control the direct voltage of each of the controllable electric power sources to optimize the estimated current efficiency or another quantity dependent on the estimated current efficiency of the electrolyser supplied by the controllable electric power source.

In accordance with the invention, there is provided also a new computer program product. The computer program product comprises a non-volatile computer readable medium, e.g. a compact disc “CD”, encoded with a computer program according to the invention.

Exemplifying and non-limiting embodiments are described in accompanied dependent claims.

Various exemplifying and non-limiting embodiments both as to constructions and to methods of operation, together with additional objects and advantages thereof, will be best understood from the following description of specific exemplifying and non-limiting embodiments when read in conjunction with the accompanying drawings.

The verbs “to comprise” and “to include” are used in this document as open limitations that neither exclude nor require the existence of unrecited features.

The features recited in dependent claims are mutually freely combinable unless otherwise explicitly stated.

Furthermore, it is to be understood that the use of “a” or “an”, i.e. a singular form, throughout this document does not exclude a plurality.

### BRIEF DESCRIPTION OF THE FIGURES

Exemplifying and non-limiting embodiments and their advantages are explained in greater detail below in the sense of examples and with reference to the accompanying drawings, in which:

FIG. 1 illustrates an electrolyser system that comprises an electrolyser and an estimation system according to an exemplifying and non-limiting embodiment for estimating current efficiency of the electrolyser,

FIG. 2 illustrates an electrolyser system according to an exemplifying and non-limiting embodiment, and

FIG. 3 shows a flowchart of an estimation method according to an exemplifying and non-limiting embodiment for estimating current efficiency of an electrolyser.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

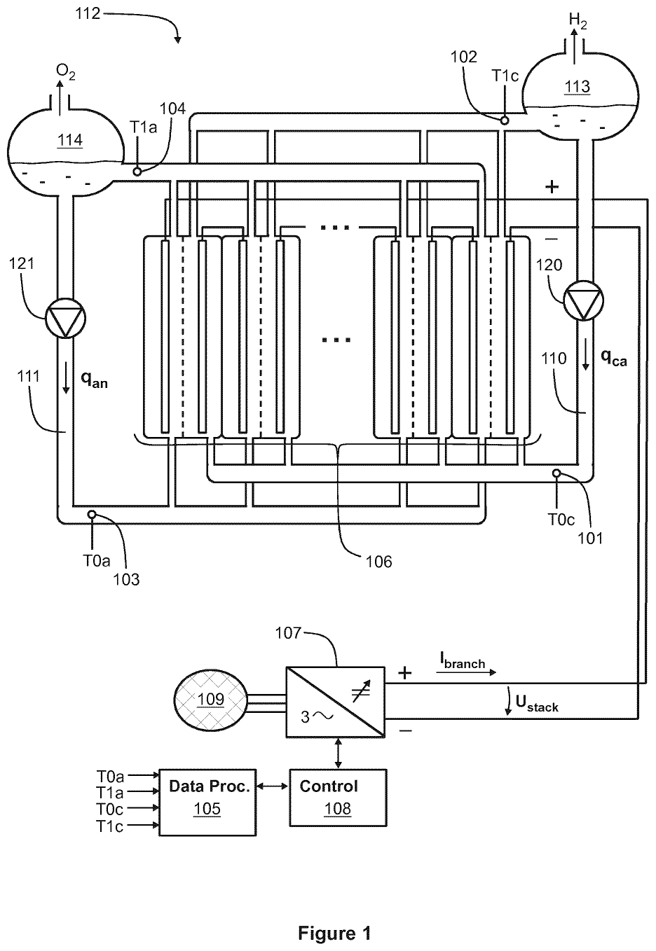

FIG. 1 illustrates an electrolyser system that comprises an electrolyser 112 and an estimation system according to an exemplifying and non-limiting embodiment for estimating current efficiency of the electrolyser 112. The electrolyser 112 comprises an electrolyser stack 106 that comprises electrolysis cells which contain electrolyte. The electrolyte can be for example alkaline liquid electrolyte for alkaline water electrolysis. The alkaline liquid electrolyte may comprise for example aqueous potassium hydroxide “KOH” or aqueous sodium hydroxide “NaOH”. It is however also possible that the electrolysis cells contain some other electrolyte. In this exemplifying electrolyser system, each of the electrolysis cells comprises an anode, a cathode, and a porous diaphragm dividing the electrolysis cell into a cathode compartment containing the cathode and an anode compartment containing the anode. The diaphragm prevents mixing of hydrogen H₂ and oxygen O₂ gases produced at the cathode and anode electrodes, respectively. Hydroxide ions are penetrating the porous diaphragm and thereby provide ionic conductivity required for the electrolysis process. The electrolyser may comprise for example tens or even hundreds of electrolysis cells. It is however also possible that an electrolyser comprises from one to ten electrolysis cells. In the exemplifying electrolyser stack 106 illustrated in FIG. 1, the electrolysis cells are electrically series connected. It is however also possible that electrolysis cells of an electrolyser system according to an exemplifying and non-limiting embodiment are electrically parallel connected, or the electrolytic cells are arranged to constitute series connected groups of parallel connected electrolysis cells, or parallel connected groups of series connected electrolysis cells, or the electrolysis cells are electrically connected to each other in some other way.

The electrolyser 112 comprises a hydrogen separator tank 113 and a piping from the cathode compartments of the electrolysis cells to the hydrogen separator tank 113. The electrolyser 112 comprises an oxygen separator tank 114 and a piping from the anode compartments of the electrolysis cells to the oxygen separator tank 114. The electrolyser 112 comprises a circulation piping 110 and a circulation pump 120 configured to circulate the liquid electrolyte from a lower portion of the hydrogen separator tank 113 to lower portions of the cathode compartments of the electrolysis cells. The electrolyser 112 comprises a circulation piping 111 and a circulation pump 121 configured to circulate the liquid electrolyte from a lower portion of the oxygen separator tank 114 to lower portions of the anode compartments of the electrolysis cells. The electrolyte in the circulation piping 110 and the electrolyte in the circulation piping 111 constitute paths for stray electric currents, i.e. shunt electric currents, which bypass the electrolyser stack 106. Therefore, electric current I_{branch} which is supplied to the electrolyser 112 does not fully contribute the water decomposition in the electrolyser stack 106. The electric current I_{stack} which flows through the electrolyser stack 106 and thus contributes the water decomposition is I_{stack}=ηc I_{branch}, where η_{C} is the current efficiency of the electrolyser 112. Correspondingly, the stray electric currents are I_{stray} is (1−η_{C}) I_{branch}. Furthermore, the electrolyte in the anode side and the electrolyte in the cathode side may be continuously or periodically mixed to minimize the concentration gradient generated in alkaline water electrolysis. Valve controlled electrolyte mixing may provide an additional stray current pathway. The valves for mixing are not shown in FIG. 1. In the exemplifying electrolyser system illustrated in FIG. 1, the electric current I_{branch} is supplied to the electrolyser 112 with a controllable electric power source 107 which is connected to a three-phase power grid 109.

The estimation system for estimating the current efficiency η_{C} comprises a temperature sensor 101 configured to measure temperature T0c of the electrolyte at an inlet of the electrolyte circulation of the cathode side of the electrolyser 112, a temperature sensor 102 configured to measure temperature T1c of the electrolyte at an outlet of the electrolyte circulation of the cathode side, a temperature sensor 103 configured to measure temperature T0a of the electrolyte at an inlet of the electrolyte circulation of the anode side of the electrolyser 112, and a temperature sensor 104 configured to measure temperature T1a of the electrolyte at an outlet of the electrolyte circulation of the anode side of the electrolyser 112.

The estimation system comprises a data processing system 105 that is configured to receive data indicative of the above-mentioned temperatures T0c, T1c, T0a, and T1a. The data processing system 105 is configured to compute an estimate for heat loss Qₗₒₛₛ in the electrolyser 112 based on the specific heat capacity Cₑ of the electrolyte, a flow rate q_{ca} of the electrolyte in the electrolyte circulation in the cathode side, a flow rate qₐₙ of the electrolyte in the electrolyte circulation in the anode side, a temperature difference ΔT_{c}=T1c−T0c of the electrolyte between the outlet and inlet of the cathode side, and a temperature difference ΔTₐ=T1c−T0c of the electrolyte between the outlet and inlet of the anode side. The data processing system 105 is configured to compute an estimate for the current efficiency η_{C} based on a difference between electric power, U_{stack}×I_{branch}, supplied to the electrolyser 112 and the computed estimate of the heat loss Qₗₒₛₛ of the electrolyser, and on a product of total thermoneutral voltage of the electrolysis cells of the electrolyser and the electric current I_{branch} supplied to the electrolyser 112.

In an estimation system according to an exemplifying and non-limiting embodiment, the data processing system 105 is configured to estimate the current efficiency ηc in accordance with the following equation:

$${η}_{C} = ( {U}_{stack} {I}_{branch} - {Q}_{loss} ) / ( {NU}_{tn} {I}_{branch} ) , \qquad ( 1 )$$

where N is the number of cells in series in the electrolyser stack 106, and Uₜₙ is thermoneutral voltage of each of the electrolysis cells. In an estimation system according to an exemplifying and non-limiting embodiment, the data processing system 105 is configured to estimate the thermoneutral voltage Uₜₙ according to the following equation given by R. L. LeRoy, C. T. Bowen, D. J. LeRoy: The thermodynamics of aqueous water electrolysis, J. Elechem. Soc. 127, 9, 1980 pp. 1954-1962:

$${U}_{tn} = 1.485 - 1.49 \times {10}^{- 4} \times T - 9.84 \times {10}^{- 8} \times {T}^{2} , \qquad ( 2 )$$

where T is temperature of the electrolysis cells. The temperature T can be for example a predetermined mathematical function, e.g. an arithmetic average, of the temperature values given by the temperature sensors 101-104. It is also possible that there are one or more temperature sensors inside the electrolysis cells.

In an estimation system according to an exemplifying and non-limiting embodiment, the data processing system 105 is configured to compute the heat loss Qₗₒₛₛ of the electrolyser 112 in accordance with the following equation:

$${Q}_{loss} = {C}_{e} ( {q}_{ca} Δ {T}_{c} + {q}_{an} Δ {T}_{a} ) k / 3.6 , \qquad ( 3 )$$

where Cₑ is the specific heat capacity of the electrolyte, q_{ca} is the flow rate of the electrolyte of the electrolyte circulation of the cathode side, ΔT_{c}=T1c−T0c is the temperature difference between the outlet and inlet of the cathode side, qₐₙ is the flow rate of the electrolyte of the electrolyte circulation of the anode side, ΔTₐ=T1c−T0c is the temperature difference between the outlet and inlet of the anode side, and k is a constant. In an exemplifying case in which the flows rates q_{ca} and qₐₙ are volumetric flow rates in liters/hour and the specific heat capacity Cₑ is in KJ/kg° C., the constant k is the density p of the electrolyte in kg/liter. In another exemplifying case in which the flows rates q_{ca} and qₐₙ are mass flow rates in kg/hour and the specific heat capacity Cₑ is in KJ/kg° C., the constant k is 1.

The heat loss Qₗₒₛₛ of the electrolyser 112 can be computed more accurately by using separate specific heat capacity values for the electrolyte in the cathode side, i.e. catholyte, and for the electrolyte in the anode side, i.e. anolyte. In an estimation system according to an exemplifying and non-limiting embodiment, the data processing system 105 is configured to compute the heat loss Qₗₒₛₛ of the electrolyser 112 in accordance with the following equation:

$${Q}_{loss} = ( {C}_{e \_ ca} {q}_{ca} Δ {T}_{c} + {C}_{e \_ an} {q}_{an} Δ {T}_{a} ) k / 3.6 , \qquad ( 4 )$$

where C_{e_ca} is the specific heat capacity of the electrolyte in the cathode side i.e. the specific heat capacity of the catholyte, and C_{e_an} is the specific heat capacity of the electrolyte in the anode side i.e. the specific heat capacity of the anolyte.

In an estimation system according to an exemplifying and non-limiting embodiment, the data processing system 105 is configured to determine the specific heat capacity C_{e_ca} as a function of temperature of the electrolyte, the catholyte, in the cathode side, and, correspondingly, to determine the specific heat capacity C_{e_an} as a function of temperature of the electrolyte, the anolyte, in the anode side. The values of C_{e_ca} and C_{e_an} can be determined with the aid of lookup tables or mathematical equations indicative of C_{e_ca} and C_{e_an} as functions of their temperatures.

Furthermore, the values of C_{e_ca} and C_{e_an} can be dependent on chemical contents of the anolyte and the catholyte, respectively. The chemical contents of the anolyte and the catholyte may change over time due to redox reaction active on the electrodes. Furthermore, the number of start and stops and/or operating time may affects the chemical contents of the anolyte and the catholyte and thus their thermodynamic properties and thereby the values of C_{e_ca} and Cₑ_an. In an estimation system according to an exemplifying and non-limiting embodiment, the data processing system 105 is configured to determine the specific heat capacity C_{e_ca} as a multivariable function of temperature of the catholyte, the number of starts and stops, and/or operating time. Correspondingly, the data processing system 105 is configured to determine the specific heat capacity C_{e_an} to determine the specific heat capacity C_{e_an} as a multivariable function of temperature of the anolyte, the number of starts and stops, and/or operating time. The values of C_{e_ca} and C_{e_an} can be determined with the aid of lookup tables or mathematical equations indicative of C_{e_ca} and C_{e_an} as the above-mentioned multivariable functions.

The ideal stack heat loss corresponding to a case where all electric current supplied to the electrolyser stack 106 participates to the electrolysis reaction is:

$${Q}_{ideal} = ( {U}_{stack} - {NU}_{tn} ) {η}_{C} {I}_{branch} , \qquad ( 5 )$$

where η_{C} I_{branch} is the electric current supplied to the electrolyser stack 106. The heat loss Qₗₒₛₛ of the electrolyser 112 is Q_{ideal}+U_{stack} (1−ηc) I_{branch}, i.e. the ideal stack heat loss plus the heat loss in the stray current paths. Thus:

$${Q}_{loss} = ( {U}_{stack} - {NU}_{tn} ) {η}_{C} {I}_{branch} + {U}_{stack} ( 1 - {η}_{C} ) {I}_{branch} . \qquad ( 6 )$$

Solving η_{C} from equation 5 gives the above-presented equation 1 of the current efficiency ηc.

In an electrolyser system according to an exemplifying and non-limiting embodiment, the data processing system 105 is configured to estimate the hydrogen H₂ production rate, e.g. in mol/s, with the aid of the following equation:

$${dn}_{H 2} / dt = {η}_{C} {I}_{branch} / ( zF ) , \qquad ( 7 )$$

where z is the valency of hydrogen H₂=2 and F is Faraday's constant 96485 Coulombs/mol. Equation 6 is based on an assumption that the Faraday efficiency nr in hydrogen production can be estimated with the current efficiency η_{C} and that the hydrogen production rate is linearly proportional to the electric current η_{C} I_{branch} of the electrolyser stack 106.

In an electrolyser system according to an exemplifying and non-limiting embodiment, the data processing system 105 is configured to compute the specific energy consumption Eₛ, e.g. in Watts/mol, of the electrolyser 112 in accordance with the following formula:

$${E}_{s} = zF \int {U}_{stack} {I}_{branch} dt / ( \int {η}_{C} {I}_{branch} dt ) . \qquad ( 8 )$$

The electrolyser system further comprises a control system 108 configured to control the direct voltage U_{stack} supplied to the electrolyser 112 to optimize a quantity dependent on the estimated current efficiency η_{C} of the electrolyser 112. For example, the direct voltage U_{stack} can be changed with small steps as long the quantity being optimized gets better, or some other suitable optimization method can be used. The quantity to be optimized can be for example the estimated current efficiency η_{C} itself, or the specific energy consumption Eₛ according to equation 7, or some other suitable quantity dependent on the estimated current efficiency ηc.

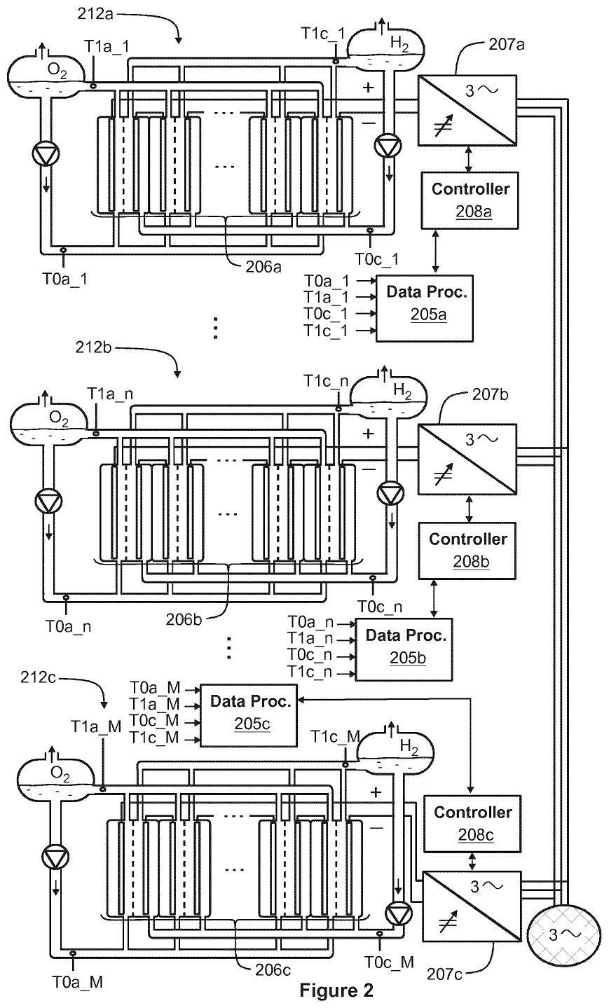

FIG. 2 illustrates an electrolyser system according to an exemplifying and non-limiting embodiment. The electrolyser system comprises M electrolysers three of which are shown and denoted with references 212a, 212b, and 212c in FIG. 2. Each of the electrolysers can be for example like the electrolyser 112 illustrated in FIG. 1. The electrolyser system comprises controllable electric power sources each being configured to supply controllable direct voltage to one of the electrolysers so that each of the electrolysers is supplied with one of the controllable electric power sources. Three of the controllable electric power sources are shown and denoted with references 207a, 207b, and 207c in FIG. 2. The electrolyser system comprises a control system configured to control the direct voltage of each of the controllable electric power sources. The direct voltage of each electrolyser is controlled to optimize a quantity dependent on the current efficiency of the electrolyser under consideration. The quantity to be optimized can be for example the current efficiency itself, or the specific energy consumption of the electrolyser under consideration, or some other suitable quantity dependent on the current efficiency. In this exemplifying case, the control system comprises electrolyser-specific controllers each being configured to control one of the controllable electric power sources. Three of the controllers are shown and denoted with references 208a, 208b, and 208c in FIG. 2. It is also possible that the control system is implemented as a single central controller that is configured to control all the controllable electric power sources.

The electrolyser system comprises an estimation system for estimating the current efficiencies η_{C,1}, . . . , η_{C,n}, . . . , η_{C,M} of the electrolysers. In this exemplifying case, the estimation system comprises temperature sensors and electrolyser-specific data processing systems for estimating the current efficiencies of the electrolysers based on the measured temperatures and on voltages and currents supplied to the electrolysers. Three of the data processing systems are shown and denoted with references 205a, 205b, and 205c in FIG. 2. Each of the data processing systems can be for example like the data processing system 105 shown in FIG. 1. For example, the data processing system 205a receives measured temperatures T0a_1, T1a_1, T0c_1, and T1c_1, the data processing system 205b receives measured temperatures T0a_n, T1a_n, T0c_n, and T1c_n, and the data processing system 205c receives measured temperatures T0a_M, T1a_M, T0c_M, and T1c_M. It is also possible that the estimation system is implemented as a single central processor that is configured to estimate all the current efficiencies η_{C,1}, . . . , η_{C,M}.

In the electrolyser system illustrated in FIG. 2, the electrolysers can be controlled individually so that operation of each electrolyser can be optimized independently of the other electrolysers. This improves the overall performance of the electrolyser system.

Each of the data processing systems 105, 205a-205c and each of the controllers 108, 208a-208c shown in FIGS. 1 and 2 may comprise one or more analogue circuits, one or more digital processing circuits, or a combination thereof. Each digital processing circuit can be a programmable processor circuit provided with appropriate software, a dedicated hardware processor such as for example an application specific integrated circuit “ASIC”, or a configurable hardware processor such as for example a field programmable gate array “FPGA”. Furthermore, each of the data processing systems and each of the controllers may comprise one or more memory circuits each of which can be for example a Random-Access Memory “RAM” circuit. It is to be noted that the data processing systems and the controllers shown in FIGS. 1 and 2 are functional entities. These functional entities can be implemented in many ways. For example, these functional entities can be implemented with separate hardware elements, or a single hardware element can be used for implementing two or more of the functional entities, e.g. the data processing system 105 and the control system 108 shown in FIG. 1 can be implemented with a same hardware element or with separate hardware elements.

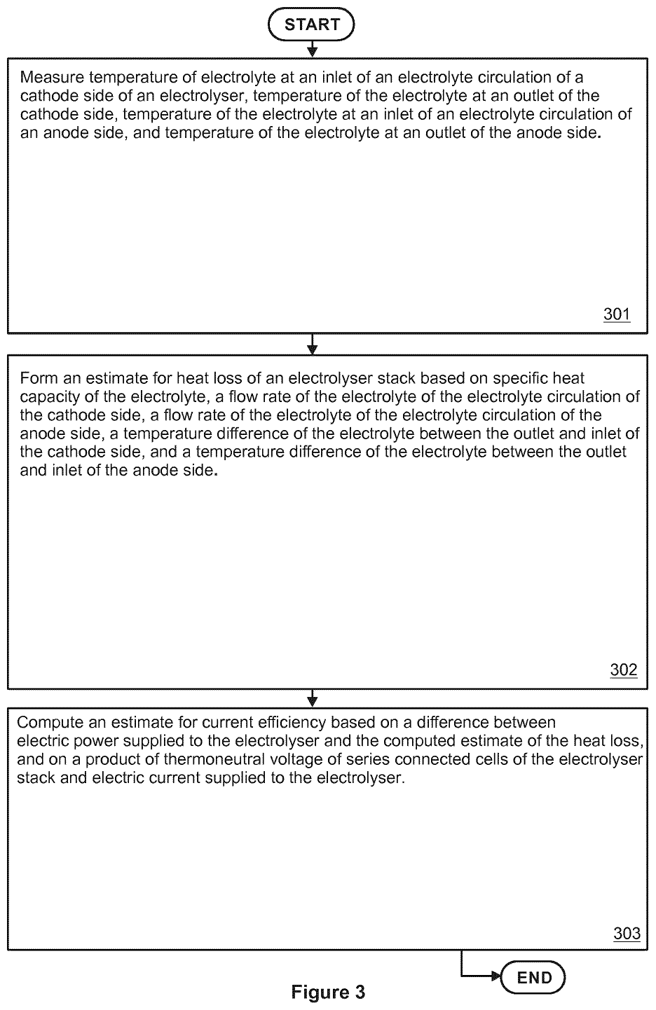

FIG. 3 shows a flowchart of an estimation method according to an exemplifying and non-limiting embodiment for estimating current efficiency η_{C} of an electrolyser. The estimation method comprises the following actions:
action 301: measuring temperature of electrolyte at an inlet of an electrolyte circulation of a cathode side of the electrolyser, temperature of the electrolyte at an outlet of the electrolyte circulation of the cathode side of the electrolyser, temperature of the electrolyte at an inlet of an electrolyte circulation of an anode side of the electrolyser, and temperature of the electrolyte at an outlet of the electrolyte circulation of the anode side of the electrolyser,
action 302: forming an estimate for heat loss Qₗₒₛₛ of the electrolyser based on specific heat capacity Cₑ of the electrolyte, a flow rate q_{ca} of the electrolyte of the electrolyte circulation of the cathode side, a flow rate qₐₙ of the electrolyte of the electrolyte circulation of the anode side, a temperature difference ΔT_{ca} of the electrolyte between the outlet and inlet of the cathode side, and a temperature difference ΔTₐₙ of the electrolyte between the outlet and inlet of the anode side, and
action 303: forming an estimate for the current efficiency η_{C} based on a difference between electric power U_{stack}×I_{branch} supplied to the electrolyser and the computed estimate of the heat loss Qₗₒₛₛ of the electrolyser, and on a product of thermoneutral voltage N×Uₜₙ of electrolysis cells of the electrolyser and electric current I_{branch} supplied to the electrolyser.

An estimation method according to an exemplifying and non-limiting embodiment comprises estimating the current efficiency ne in accordance with a following equation:

$${η}_{C} = ( {U}_{stack} {I}_{branch} - {Q}_{loss} ) / ( {NU}_{tn} {I}_{branch} ) , \qquad ( 9 )$$

where U_{stack} is voltage over the electrolyser, I_{branch} is the electric current supplied to the electrolyser, N is the number of electrolysis cells in series in the electrolyser, and Uₜₙ is thermoneutral voltage of each one of the electrolysis cells.

An estimation method according to an exemplifying and non-limiting embodiment comprises estimating the above-mentioned thermoneutral voltage Uₜₙ according to the following equation:

$${U}_{tn} = 1.485 - 1.49 \times {10}^{- 4} \times T - 9.84 \times {10}^{- 8} \times {T}^{2} , \qquad ( 10 )$$

where T is temperature of the electrolysis cells.

An estimation method according to an exemplifying and non-limiting embodiment comprises estimating the temperature T of the electrolysis cells to be a predetermined mathematical function, e.g. an arithmetic average, of values of the temperatures of the electrolyte at the inlet and outlet of the cathode side and at the inlet and outlet of the anode side.

An estimation method according to an exemplifying and non-limiting embodiment comprises computing the heat loss Qₗₒₛₛ of the electrolyser in accordance with the following equation:

$${Q}_{loss} = {C}_{e} ( {q}_{ca} Δ {T}_{ca} + {q}_{an} Δ {T}_{an} ) k / 3.6 , \qquad ( 11 )$$

where Cₑ is the specific heat capacity of the electrolyte, q_{ca} is the flow rate of the electrolyte of the electrolyte circulation of the cathode side, ΔT_{ca} is the temperature difference between the outlet and inlet of the cathode side, qₐₙ is the flow rate of the electrolyte of the electrolyte circulation of the anode side, ΔT_{ca} is the temperature difference between the outlet and inlet of the anode side, and k is a constant.

An estimation method according to an exemplifying and non-limiting embodiment comprises computing the heat loss Qₗₒₛₛ of the electrolyser in accordance with the following equation:

$${Q}_{loss} = ( {C}_{e\_ca} {q}_{ca} Δ {T}_{c} + {C}_{e\_an} {q}_{an} Δ {T}_{a} ) k / 3.6 \qquad ( 12 )$$

where C_{e_ca} is the specific heat capacity of the electrolyte in the cathode side i.e. the specific heat capacity of the catholyte, and C_{e_an} is the specific heat capacity of the electrolyte in the anode side i.e. the specific heat capacity of the anolyte.

A control method according to an exemplifying and non-limiting embodiment is suitable for controlling an electrolyser system that comprises:
one or more electrolysers each comprising an electrolyser stack having electrolysis cells containing electrolyte, and
one or more controllable electric power sources each being configured to supply controllable direct voltage to one of the electrolysers so that each of the electrolysers is supplied with one of the controllable electric power sources.

The above-mentioned control method comprises:
carrying out an estimation method according to an exemplifying and non-limiting embodiment for estimating current efficiency of each of the electrolysers, and
controlling the direct voltage of each of the controllable electric power sources to optimize a quantity dependent on the estimated current efficiency of the electrolyser supplied by the controllable electric power source under consideration.

A control method according to an exemplifying and non-limiting embodiment comprises computing a specific energy consumption of each of the electrolysers in accordance with the below-presented equation 12 and controlling the direct voltage of each of the controllable electric power sources to minimize the specific energy consumption of the electrolyser supplied by the controllable electric power source:

$${E}_{s , n} = zF \int {U}_{stack , n} {I}_{branch , n} dt / ( \int η {c}_{, n} {I}_{branch , n} dt ) \qquad ( 13 )$$

where E_{s,n} is specific energy consumption of n^{th} one of the electrolysers, U_{stack},n is the controllable direct voltage supplied to the n^{th} one of the electrolysers, I_{branch},n is electric current supplied to the n^{th} one of the electrolysers, η_{C,n} is the estimated current efficiency of the n^{th} one of the electrolysers, z is valency of hydrogen H₂=2, and F is Faraday's constant 96485 Coulombs/mol.

A computer program according to an exemplifying and non-limiting embodiment comprises computer executable instructions for controlling a programmable data processing system to carry out actions related to an estimation method and/or a control method according to any of the above-described exemplifying and non-limiting embodiments.

A computer program according to an exemplifying and non-limiting embodiment comprises software modules for estimating current efficiency of an electrolyser. The software modules comprise computer executable instructions for controlling a programmable processor to:
receive temperature values indicative of temperature of electrolyte at an inlet of an electrolyte circulation of a cathode side of the electrolyser, temperature of the electrolyte at an outlet of the electrolyte circulation of the cathode side of the electrolyser, temperature of the electrolyte at an inlet of an electrolyte circulation of an anode side the of electrolyser, and temperature of the electrolyte at an outlet of the electrolyte circulation of the anode side of the electrolyser,
form an estimate for heat loss of the electrolyser based on specific heat capacity of the electrolyte, a flow rate of the electrolyte of the electrolyte circulation of the cathode side, a flow rate of the electrolyte of the electrolyte circulation of the anode side, a temperature difference of the electrolyte between the outlet and inlet of the cathode side, and a temperature difference of the electrolyte between the outlet and inlet of the anode side, and
compute an estimate for the current efficiency based on a difference between electric power supplied to the electrolyser and the computed estimate of the heat loss of the electrolyser, and on a product of thermoneutral voltage of electrolysis cells of the electrolyser and electric current supplied to the electrolyser.

The above-mentioned software modules can be e.g. subroutines or functions implemented with a suitable programming language.

A computer program according to an exemplifying and non-limiting embodiment comprises software modules for controlling an electrolyser system that comprises:
one or more electrolysers each comprising an electrolyser stack having electrolysis cells containing electrolyte, and
one or more controllable electric power sources each being configured to supply controllable direct voltage to one of the electrolysers so that each of the electrolysers is supplied with one of the controllable electric power sources:

The software modules of the computer program for controlling the above-mentioned electrolyser system comprise:
software modules of a computer program according to an exemplifying and non-limiting embodiment for estimating the current efficiency of each electrolyser of the electrolyser system, and
computer executable instructions for controlling a programmable data processing system to control direct voltage of each of the one or more controllable electric power sources to optimize a quantity dependent on the estimated current efficiency of the electrolyser supplied by the controllable electric power source under consideration.

A computer program product according to an exemplifying and non-limiting embodiment comprises a non-transitory computer readable medium, e.g. a compact disc “CD”, encoded with a computer program according to an embodiment of invention.

A signal according to an exemplifying and non-limiting embodiment is encoded to carry information defining a computer program according to an embodiment of invention. In this exemplifying case, the computer program can be downloadable from a server that may constitute e.g. a part of a cloud service.

The specific examples provided in the description given above should not be construed as limiting the applicability and/or the interpretation of the appended claims. Lists and groups of examples provided in the description given above are not exhaustive unless otherwise explicitly stated.

1. An estimation system for estimating current efficiency of an electrolyser, the estimation system comprising temperature sensors at an inlet of an electrolyte circulation of a cathode side of the electrolyser, at an outlet of the electrolyte circulation of the cathode side of the electrolyser, at an inlet of an electrolyte circulation of an anode side of the electrolyser, and at an outlet of the electrolyte circulation of the anode side of the electrolyser, wherein the estimation system comprises a data processing system configured to compute:
an estimate for heat loss of the electrolyser based on specific heat capacity of electrolyte, a flow rate of the electrolyte of the electrolyte circulation of the cathode side, a flow rate of the electrolyte of the electrolyte circulation of the anode side, a temperature difference of the electrolyte between the outlet and inlet of the cathode side, and a temperature difference of the electrolyte between the outlet and inlet of the anode side, and
an estimate for the current efficiency based on a difference between electric power supplied to the electrolyser and the computed estimate of the heat loss of the electrolyser, and on a product of thermoneutral voltage of electrolysis cells of the electrolyser and electric current supplied to the electrolyser.

2. An estimation system according to claim 1, wherein the data processing system is configured to estimate the current efficiency h_{C} in accordance with a following equation:
$${h}_{C} = ( {U}_{stack} {I}_{branch} - {Q}_{loss} ) / ( N {U}_{tn} {I}_{branch} ) ,$$
where U_{stack} is voltage over the electrolyser, I_{branch} is the electric current supplied to the electrolyser, N is a number of electrolysis cells in series in the electrolyser, and Uₜₙ is thermoneutral voltage of each one of the electrolysis cells.

3. An estimation system according to claim 1, wherein the data processing system is configured to estimate the thermoneutral voltage Uₜₙ according to a following equation:
$${U}_{tn} = 1.485 - 1.49 \times 1 {0}^{- 4} \times T - 9.84 \times 1 {0}^{- 8} \times {T}^{2} ,$$
where T is temperature of the electrolysis cells.

4. An estimation system according to claim 3, wherein the data processing system is configured to compute the temperature of the electrolysis cells to be a predetermined mathematical function of temperature values given by the temperature sensors.

5. An estimation system according to claim 1, wherein the data processing system is configured to compute the heat loss Qₗₒₛₛ of the electrolyser in accordance with a following equation:
$${Q}_{loss} = ( {C}_{e\_ca} {q}_{ca} {DT}_{c} + {C}_{e\_an} {q}_{an} {DT}_{a} ) k / 3.6 ,$$
where C_{e_ca} is the specific heat capacity of the electrolyte of the cathode side, C_{e_an} is the specific heat capacity of the electrolyte of the anode side, q_{ca} is the flow rate of the electrolyte of the electrolyte circulation of the cathode side, DTₑ is the temperature difference between the outlet and inlet of the cathode side, qₐₙ is the flow rate of the electrolyte of the electrolyte circulation of the anode side, DTₐ is the temperature difference between the outlet and inlet of the anode side, and k is a constant.

6. An electrolyser system comprising:
one or more electrolysers each comprising an electrolyser stack having electrolysis cells containing electrolyte,
one or more controllable electric power sources each being configured to supply controllable direct voltage to one of the electrolysers so that each of the electrolysers is supplied with one of the controllable electric power sources,
a control system configured to control the direct voltage of each of the one or more controllable electric power sources to optimize a quantity dependent on current efficiency the) of the electrolyser supplied by the controllable electric power source, and
an estimation system for estimating the current efficiency of each of the electrolysers,
the estimation system comprising temperature sensors at an inlet of an electrolyte circulation of a cathode side of the electrolyser, at an outlet of the electrolyte circulation of the cathode side of the electrolyser, at an inlet of an electrolyte circulation of an anode side of the electrolyser, and at an outlet of the electrolyte circulation of the anode side of the electrolyser, wherein the estimation system comprises a data processing system configured to compute:
an estimate for heat loss of the electrolyser based on specific heat capacity of electrolyte, a flow rate of the electrolyte of the electrolyte circulation of the cathode side, a flow rate of the electrolyte of the electrolyte circulation of the anode side, a temperature difference of the electrolyte between the outlet and inlet of the cathode side, and a temperature difference of the electrolyte between the outlet and inlet of the anode side, and
an estimate for the current efficiency based on a difference between electric power supplied to the electrolyser and the computed estimate of the heat loss of the electrolyser, and on a product of thermoneutral voltage of electrolysis cells of the electrolyser and electric current supplied to the electrolyser.

7. An electrolyser system according to claim 6, wherein the data processing system of the estimation system is configured to compute a specific energy consumption related to each of the electrolysers in accordance with a following formula and the control system is configured to control the direct voltage (U_{stack,n}) of each of the controllable electric power sources to minimize the specific energy consumption related to the electrolyser supplied by the controllable electric power source:
$${E}_{s , n} = zF \int {U}_{stack , n} {I}_{br anch , n} dt / ( \int {h}_{C , n} {I}_{branch , n} dt )$$
where E_{s,n} is the specific energy consumption of n^{th} one of the electrolysers, U_{stack,n} is the controllable direct voltage supplied to the n^{th} one of the electrolysers, I_{branch,n} is electric current supplied to the n^{th} one of the electrolysers, hon is the current efficiency of the n^{th} one of the electrolysers, z is valency of hydrogen H₂=2, and F is Faraday's constant 96485 Coulombs/mol.

8. An estimation method for estimating current efficiency of an electrolyser, the estimation method comprising:
measuring temperature of electrolyte at an inlet of an electrolyte circulation of a cathode side of the electrolyser, temperature of the electrolyte at an outlet of the electrolyte circulation of the cathode side of the electrolyser, temperature of the electrolyte at an inlet of an electrolyte circulation of an anode side of the electrolyser, and temperature of the electrolyte at an outlet of the electrolyte circulation of the anode side of the electrolyser,
forming, by a data processing system, an estimate for heat loss of the electrolyser based on specific heat capacity of the electrolyte, a flow rate of the electrolyte of the electrolyte circulation of the cathode side, a flow rate of the electrolyte of the electrolyte circulation of the anode side, a temperature difference of the electrolyte between the outlet and inlet of the cathode side, and a temperature difference of the electrolyte between the outlet and inlet of the anode side, and
forming, by the data processing system, an estimate for the current efficiency based on a difference between electric power supplied to the electrolyser and the computed estimate of the heat loss of the electrolyser, and on a product of thermoneutral voltage of electrolysis cells of the electrolyser and electric current supplied to the electrolyser.

9. An estimation method according to claim 8, wherein the estimation method comprises estimating the current efficiency h_{C} in accordance with a following equation:
$${h}_{C} = ( {U}_{stack} {I}_{branch} - {Q}_{loss} ) / ( N {U}_{tn} {I}_{branch} ) ,$$
where U_{stack} is voltage over the electrolyser, I_{branch} is the electric current supplied to the electrolyser, N is a number of electrolysis cells in series in the electrolyser, and Uₜₙ is thermoneutral voltage of each one of the electrolysis cells.

10. An estimation method according to claim 8, wherein the estimation method comprises estimating the thermoneutral voltage Un according to a following equation:
$${U}_{tn} = 1.485 - 1.49 \times 1 {0}^{- 4} \times T - 9.84 \times 1 {0}^{- 8} \times {T}^{2} ,$$
where T is temperature of the electrolysis cells.

11. An estimation method according to claim 10, wherein the estimation method comprises estimating the temperature of the electrolysis cells to be a predetermined mathematical function of values of the temperatures of the electrolyte at the inlet and outlet of the cathode side and at the inlet and outlet of the anode side.

12. An estimation method according to claim 8, wherein the estimation method comprises computing the heat loss Qₗₒₛₛ of the electrolyser in accordance with a following equation:
$${Q}_{loss} = ( {C}_{e\_ca} {q}_{ca} {DT}_{ca} + {C}_{e\_an} {q}_{an} {DT}_{an} ) k / 3.6 ,$$
where C_{e_ca} is the specific heat capacity of the electrolyte of the cathode side, C_{e_an} is the specific heat capacity of the electrolyte of the anode side, q_{ca} is the flow rate of the electrolyte of the electrolyte circulation of the cathode side, DT_{ca} is the temperature difference between the outlet and inlet of the cathode side, qₐₙ is the flow rate of the electrolyte of the electrolyte circulation of the anode side, DT_{ca} is the temperature difference between the outlet and inlet of the anode side, and k is a constant.

13. A control method for controlling an electrolyser system that comprises:
one or more electrolysers each comprising an electrolyser stack having electrolysis cells containing electrolyte, and
one or more controllable electric power sources each being configured to supply controllable direct voltage to one of the electrolysers so that each of the electrolysers is supplied with one of the controllable electric power sources,
the control method comprising controlling, by a control system, the direct voltage of each of the one or more controllable electric power sources to optimize a quantity dependent on current efficiency of the electrolyser supplied by the controllable electric power source, wherein the control method comprises carrying out an estimation method for estimating the current efficiency of each of the electrolysers, the estimation method comprising:
measuring temperature of electrolyte at an inlet of an electrolyte circulation of a cathode side of the electrolyser, temperature of the electrolyte at an outlet of the electrolyte circulation of the cathode side of the electrolyser, temperature of the electrolyte at an inlet of an electrolyte circulation of an anode side of the electrolyser, and temperature of the electrolyte at an outlet of the electrolyte circulation of the anode side of the electrolyser,
forming, by a data processing system, an estimate for heat loss of the electrolyser based on specific heat capacity of the electrolyte, a flow rate of the electrolyte of the electrolyte circulation of the cathode side, a flow rate of the electrolyte of the electrolyte circulation of the anode side, a temperature difference of the electrolyte between the outlet and inlet of the cathode side, and a temperature difference of the electrolyte between the outlet and inlet of the anode side, and
forming, by the data processing system, an estimate for the current efficiency based on a difference between electric power supplied to the electrolyser and the computed estimate of the heat loss of the electrolyser, and on a product of thermoneutral voltage of electrolysis cells of the electrolyser and electric current supplied to the electrolyser.

14. A control method according to claim 13, wherein the control method comprises computing a specific energy consumption of each of the electrolysers in accordance with a following formula and controlling the direct voltage of each of the controllable electric power sources to minimize the specific energy consumption of the electrolyser supplied by the controllable electric power source:
$${E}_{s , n} = zF \int {U}_{stack , n} {I}_{branch , n} dt / ( \int {h}_{C , n} {I}_{branch , n} dt )$$
where E_{s,n} is the specific energy consumption of n^{th} one of the electrolysers, U_{stack,n} is the controllable direct voltage supplied to the n^{th} one of the electrolysers, I_{branch,n} is electric current supplied to the n^{th} one of the electrolysers, h_{C,n} is the current efficiency of the n^{th} one of the electrolysers, z is valency of hydrogen H₂=2, and F is Faraday's constant 96485 Coulombs/mol.

15. A non-transitory computer readable medium encoded with a computer program for estimating current efficiency of an electrolyser, the computer program comprising computer executable instructions for controlling a programmable data processing system to:
receive temperature values indicative of temperature of electrolyte at an inlet of an electrolyte circulation of a cathode side of the electrolyser, temperature of the electrolyte at an outlet of the electrolyte circulation of the cathode side of the electrolyser, temperature of the electrolyte at an inlet of an electrolyte circulation of an anode side the of electrolyser, and temperature of the electrolyte at an outlet of the electrolyte circulation of the anode side of the electrolyser,
form an estimate for heat loss of the electrolyser based on specific heat capacity of the electrolyte, a flow rate of the electrolyte of the electrolyte circulation of the cathode side, a flow rate of the electrolyte of the electrolyte circulation of the anode side, a temperature difference of the electrolyte between the outlet and inlet of the cathode side, and a temperature difference of the electrolyte between the outlet and inlet of the anode side, and
compute an estimate for the current efficiency the) based on a difference between electric power supplied to the electrolyser and the computed estimate of the heat loss of the electrolyser, and on a product of thermoneutral voltage of electrolysis cells of the electrolyser and electric current supplied to the electrolyser.

16. A non-transitory computer readable medium encoded with a computer program for controlling an electrolyser system that comprises:
one or more electrolysers each comprising an electrolyser stack having electrolysis cells containing electrolyte, and
one or more controllable electric power sources each being configured to supply controllable direct voltage to one of the electrolysers so that each of the electrolysers is supplied with one of the controllable electric power sources,
the computer program comprising computer executable instructions for controlling a programmable data processing system to control the direct voltage of each of the one or more controllable electric power sources to optimize a quantity dependent on current efficiency of the electrolyser supplied by the controllable electric power source, wherein the computer program for controlling the electrolyser system comprises a computer program for estimating the current efficiency of each of the electrolysers, the computer program for estimating the current efficiency comprising computer executable instructions for controlling the programmable data processing system to:
receive temperature values indicative of temperature of electrolyte at an inlet of an electrolyte circulation of a cathode side of the electrolyser, temperature of the electrolyte at an outlet of the electrolyte circulation of the cathode side of the electrolyser, temperature of the electrolyte at an inlet of an electrolyte circulation of an anode side the of electrolyser, and temperature of the electrolyte at an outlet of the electrolyte circulation of the anode side of the electrolyser,
form an estimate for heat loss of the electrolyser based on specific heat capacity of the electrolyte, a flow rate of the electrolyte of the electrolyte circulation of the cathode side, a flow rate of the electrolyte of the electrolyte circulation of the anode side, a temperature difference of the electrolyte between the outlet and inlet of the cathode side, and a temperature difference of the electrolyte between the outlet and inlet of the anode side, and
compute an estimate for the current efficiency based on a difference between electric power supplied to the electrolyser and the computed estimate of the heat loss of the electrolyser, and on a product of thermoneutral voltage of electrolysis cells of the electrolyser and electric current supplied to the electrolyser.

17. (canceled)

18. An estimation system according to claim 2, wherein the data processing system is configured to estimate the thermoneutral voltage Uₜₙ according to a following equation:
$${U}_{m} = 1.485 - 1.49 \times 1 {0}^{- 4} \times T - 9.84 \times 1 {0}^{- 8} \times {T}^{2} ,$$
where T is temperature of the electrolysis cells.

19. An estimation system according to claim 2, wherein the data processing system is configured to compute the heat loss Qₗₒₛₛ of the electrolyser in accordance with a following equation:
$${Q}_{loss} = ( {C}_{e\_ca} {q}_{ca} {DT}_{ca} + {C}_{e\_an} {q}_{an} {DT}_{an} ) k / 3.6 ,$$
where C_{e_ca} is the specific heat capacity of the electrolyte of the cathode side, C_{e_an} is the specific heat capacity of the electrolyte of the anode side, q_{ca} is the flow rate of the electrolyte of the electrolyte circulation of the cathode side, DT_{c} is the temperature difference between the outlet and inlet of the cathode side, qₐₙ is the flow rate of the electrolyte of the electrolyte circulation of the anode side, DTₐ is the temperature difference between the outlet and inlet of the anode side, and k is a constant.

20. An estimation method according to claim 9, wherein the estimation method comprises estimating the thermoneutral voltage Um according to a following equation:
$${U}_{m} = 1.485 - 1.49 \times 1 {0}^{- 4} \times T - 9.84 \times 1 {0}^{- 8} \times {T}^{2} ,$$
where T is temperature of the electrolysis cells.
